(19) United States
(12) Patent Application Publication
(10) Pub. No.: US 2015/0077385 A1
(43) Pub. Date: Mar. 19, 2015

(54) CONTROL METHOD AND ELECTRONIC DEVICE

(71) Applicant: LENOVO (BEIJING) LIMITED, BEIJING (CN)

(72) Inventors: GUANGHUA ZHOU, BEIJING (CN); YI YANG, BEIJING (CN); QIANG ZHANG, BEIJING (CN); XUEXIA LI, BEIJING (CN); ZIDONG CUI, BEIJING (CN)

(73) Assignee: LENOVO (BEIJING) LIMITED, BEIJING (CN)

(21) Appl. No.: 14/230,597

(22) Filed: Mar. 31, 2014

(30) Foreign Application Priority Data
Sep. 16, 2013 (CN) 201310421812.9

(51) Int. Cl. G06F 3/044

(52) U.S. Cl. CPC G06F 3/044
USPC 345/174

(57) ABSTRACT

Control methods and electronic devices are provided. In one embodiment, a control method for an electronic device with a touch unit may comprise: obtaining touch operation information through the touch unit; determining a contact end corresponding to the touch operation information based on a first preset correspondence, and determining an operation instruction corresponding to the contact end based on a second preset correspondence; and executing the operation instruction to control the electronic device.

### TECHNICAL FIELD

The present disclosure generally relates to the computer technology field, and particularly, to control methods and electronic devices.

### BACKGROUND

A capacitive touch screen operates by inducing currents in human bodies. It generally comprises a four-layer composite glass screen, with an inner surface of the glass screen and a sandwiched layer respectively coated with ITO layers, and an outermost layer being a thin layer of silica glass which serves as a protection layer. The ITO coating is an operation surface, with four electrodes disposed at four corners thereof. The internal ITO layer serves as a shielding layer to ensure a good operation environment.

When a user touches the metal layer with his finger, the user and the touch screen constitute a coupling capacitance due to an electric field of the user's body. For a high-frequency current, the capacitance is a direct conductor, and thus the finger draws a small fraction of the current from a touch point. The current is consisted of currents drawn from the electrodes disposed at the four corners of the touch screen, and the current flowing through each of the four electrodes is proportional to a distance between the corner where the electrode is disposed and the touch point. A controller may determine positional information of the touch point based on proportions of the four currents.

A capacitive stylus pen, which is made of a conductive material and thus is conductive, can be used to touch the capacitive touch screen. The capacitive stylus pen can achieve more precise operations on the screen than fingers, and thus finds wide applications.

Some existing capacitive stylus pen can have both ends for operations on the capacitive screen. Generally, the two ends have the same effect. Therefore, there is a need for distinguishing different ends of a capacitive stylus pen so that an electronic device can make different responses to touches of the different ends.

### SUMMARY

The present disclosure aims to provide, among others, control methods and electronic device, to meet at least partially the need as described above.

According to an aspect of the present disclosure, there is provided a control method for an electronic device with a touch unit. The method may comprise: obtaining touch operation information through the touch unit; determining a contact end corresponding to the touch operation information based on a first preset correspondence, and determining an operation instruction corresponding to the contact end based on a second preset correspondence; and executing the operation instruction to control the electronic device.

Determining the contact end corresponding to the touch operation information based on the first preset correspondence may comprise determining the contact end corresponding to the touch operation information based on a magnetic field strength for a touch operation corresponding to the touch operation information and a preset magnetic field strength, and/or based on a magnetic field direction for a touch operation corresponding to the touch operation information.

The electronic device may comprise at least one detection unit. Determining the contact end corresponding to the touch operation information based on the first preset correspondence may comprise: determining a touch operation point on the touch unit corresponding to the touch operation information; determining a distance between the touch operation point and a first detection unit of the at least one detection unit in the electronic device, and determining a field strength increasing rate corresponding to the touch operation point; and determining the contact end corresponding to the touch operation information based on the distance and the field strength increasing rate.

Determining the distance between the touch operation point and the first detection unit may comprise: selecting one from the at least one detection unit, which is closest to the touch operation point, as the first detection unit; and determining the distance between the touch operation point and the first detection unit.

Determining the contact end corresponding to the touch operation information based on the first preset correspondence may comprise: determining a touch operation point on the touch unit corresponding to the touch operation information; determining a coordinate value of the touch operation point, and determining a field strength increasing rate corresponding to the touch operation point; and determining the contact end corresponding to the touch operation information based on the coordinate value and the field strength increasing rate.

Determining the field strength increasing rate corresponding to the touch operation point may comprise: determining a current field strength at the touch operation point; and determining the field strength increasing rate based on the current field strength and an original field strength at the touch operation point.

According to a further aspect of the present disclosure, there is provided an electronic device. The electronic device may comprise: a touch unit; an obtaining module configured to obtain touch operation information through the touch unit; a determining module configured to determine a contact end corresponding to the touch operation information based on a first preset correspondence, and to determine an operation instruction corresponding to the contact end based on a second preset correspondence; and an executing module configured to execute the operation instruction to control the electronic device.

The determining module may be further configured to determine the contact end corresponding to the touch operation information based on a magnetic field strength for a touch operation corresponding to the touch operation information and a preset magnetic field strength, and/or based on a magnetic field direction for a touch operation corresponding to the touch operation information.

The electronic device may further comprise at least one detection unit. The determining module may be further configured to: determine a touch operation point on the touch unit corresponding to the touch operation information; determine a distance between the touch operation point and a first detection unit of the at least one detection unit in the electronic device, and determine a field strength increasing rate corresponding to the touch operation point; and determine the contact end corresponding to the touch operation information based on the distance and the field strength increasing rate.

The determining module may be further configured to: select one from the at least one detection unit, which is closest to touch operation point, as the first detection unit; and determine the distance between the touch operation point and the first detection unit.

The determining module may be further configured to: determine a touch operation point on the touch unit corresponding to the touch operation information; determine a coordinate value of the touch operation point, and determine a field strength increasing rate corresponding to the touch operation point; and determine the contact end corresponding to the touch operation information based on the coordinate value and the field strength increasing rate.

The determining module may be further configured to: determine a current field strength at the touch operation point; and determine the field strength increasing rate based on the current field strength and an original field strength at the touch operation point.

According to a still further aspect of the present disclosure, there is provided an electronic device. The electronic device may comprise: a housing; and at least one contact end, one of which is disposed at an end of the housing and configured to operate on a touch unit of a further electronic device.

The electronic device may comprise two contact ends, a first one of which may correspond to a first magnetic field strength and a first magnetic field direction, and a second one of which may correspond to a second magnetic field strength and a second magnetic field direction. The first magnetic field strength may be equal to or different from the second magnetic field strength, and the first magnetic field direction may be different from the second magnetic field direction.

The electronic device may further comprise a magnetic component provided in the housing.

According to a still further aspect of the present disclosure, there is provided a control method for an electronic device with a touch unit. The method may comprise: obtaining touch operation information through the touch unit; determining a contact end corresponding to the touch operation information based on a preset correspondence, and determining an operation instruction corresponding to the contact end; and executing the operation instruction to control the electronic device.

According to embodiments of the present disclosure, the electronic device, after obtaining the touch operation information, may determine the contact end corresponding to the touch operation information based on the preset correspondence and thus determine the operation instruction corresponding to the contact end. As a result, the operation instruction may be executed to control the electronic device. For example, the contact end may comprise any of different ends of a capacitive stylus pen, any of different ends of an electromagnetic stylus pen, a finger of a user, or the like. Based on the preset correspondence, the electronic device can distinguish different contact ends and determine different operation instructions corresponding to the different contact ends, and thus make different responses. Therefore, it is possible to enrich manners in which the electronic device responds to touch operations, and thus to improve user experiences.

### BRIEF DESCRIPTION OF THE DRAWINGS

FIG. 1 is a flowchart schematically showing a control method according to an embodiment of the present disclosure;

FIG. 2 is an apparent view schematically showing a touch unit in a first electronic device according to an embodiment of the present disclosure;

FIG. 3 is a schematic view showing a configuration of a second electronic device according to an embodiment of the present disclosure;

FIG. 4 is a schematic view showing a first preset correspondence according to an embodiment of the present disclosure;

FIG. 5 is a schematic view showing a configuration of a second electronic device according to a further embodiment of the present disclosure;

FIG. 6 is a schematic view showing a first preset correspondence according to a further embodiment of the present disclosure;

FIG. 7 is a schematic view showing a configuration of a first electronic device according to an embodiment of the present disclosure; and

FIG. 8 is a schematic view showing a configuration of a second electronic device according to a further embodiment of the present disclosure.

### DETAILED DESCRIPTION

According to embodiments of the present disclosure, there is provided a control method for an electronic device with a touch unit. The method may comprise: obtaining touch operation information through the touch unit; determining a contact end corresponding to the touch operation information based on a preset correspondence, and determining an operation instruction corresponding to the contact end; and executing the operation instruction to control the electronic device.

According to embodiments of the present disclosure, the electronic device, after obtaining the touch operation information, may determine the contact end corresponding to the touch operation information based on the preset correspondence and thus determine the operation instruction corresponding to the contact end. As a result, the operation instruction may be executed to control the electronic device. For example, the contact end may comprise any of different ends of a capacitive stylus pen, any of different ends of an electromagnetic stylus pen, a finger of a user, or the like. Based on the preset correspondence, the electronic device can distinguish different contact ends and determine different operation instructions corresponding to the different contact ends, and thus make different responses. Therefore, it is possible to enrich manners in which the electronic device responds to touch operations, and thus to improve user experiences.

Objects, features, and advantages of the technology disclosed herein will become more apparent from the following descriptions of embodiments thereof with reference to the attached drawings. The embodiments are provided just for illustration, but are not intended to limit the present disclosure. Alternatives and variations are apparent to those skilled in the art.

According to embodiments of the present disclosure, the electronic device may comprise a PC (Personal Computer), a notebook computer, a PAD (or a tablet computer), a mobile phone, or the like. The present disclosure it not limited thereto.

In the context of the present disclosure, the expression “and/or” presenting two or more alternative terms should be understood to contemplate possibilities of including one of the terms, either of the terms, or both the terms. For example, the phrase “A and/or B” will be understood to include “A” alone, “B” along, or “A” and “B” together. Further, the expression “A/B” may indicate “A” or “B”.

Hereinafter, some embodiments will be described in detail with reference to the drawings.

### Embodiment 1

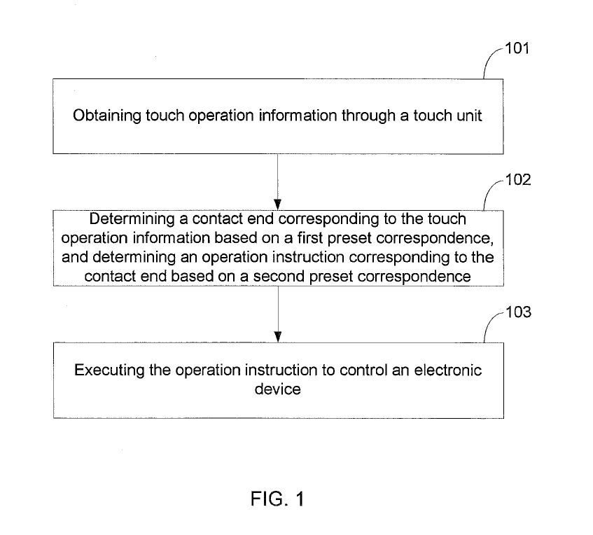

According to an embodiment of the present disclosure, there is provided a control method for a first electronic device with a touch unit. Referring to FIG. 1,the method may comprise an operation 101 of obtaining touch operation information through the touch unit.

The touch unit may comprise a touch screen included in the first electronic device. The touch screen may comprise a capacitive screen.

A user may perform a touch operation on the touch unit. The first electronic device may determine the touch operation information based on the touch operation.

Specifically, the user may perform the touch operation on the touch unit by a manipulation tool, such as, his finger or a second electronic device.

The second electronic device may comprise a capacitive stylus pen, an electromagnetic stylus pen, or any other manipulation tool suitable to operate on the touch unit.

In a case where the touch unit comprises a capacitive touch unit, the manipulation tool may comprise a finger of the user or a capacitive stylus pen. Alternatively, in a case where the touch unit comprises an electromagnetic touch unit, the manipulation tool may comprise an electromagnetic stylus pen.

In the context of the present disclosure, any end of the manipulation tool, which can operate on the touch unit, may be referred to as a contact end.

For example, if the manipulation tool is the finger of the user, then an end of this finger which can operate on the touch unit may be referred to as a contact end.

For another example, if the manipulation tool is the capacitive stylus pen, then one end or both ends of the capacitive stylus pen can operate on the touch unit. If only one end of the capacitive stylus pen can operate on the touch unit, then this end may be referred to as a contact end. Alternatively, if both the ends of the capacitive stylus pen can operate on the touch unit, then the two ends may be considered as two contact ends. That is, the capacitive stylus pen may have at least one contact end.

For still another example, if the manipulation tool is the electromagnetic stylus pen, then one end or both ends of the electromagnetic stylus pen can operate on the touch unit. If only one end of the electromagnetic stylus pen can operate on the touch unit, then this end may be referred to as a contact end. Alternatively, if both the ends of the electromagnetic stylus pen can operate on the touch unit, then the two ends may be considered as two contact ends. That is, the electromagnetic stylus pen may have at least one contact end.

The method may further comprise an operation S102 of determining a contact end corresponding to the touch operation information based on a first preset correspondence, and determining an operation instruction corresponding to the contact end based on a second preset correspondence.

The first preset correspondence may be established in the first electronic device in advance.

The operation of determining the contact end corresponding to the touch operation information based on the first preset correspondence may comprise: determining the contact end corresponding to the touch operation information based on a magnetic field strength for a touch operation corresponding to the touch operation information and a preset magnetic field strength, and/or based on a magnetic field direction for a touch operation corresponding to the touch operation information.

Specifically, after determining the touch operation information, the magnetic field strength and/or the magnetic field direction for the touch operation at a touch operation point on the touch unit corresponding to the touch operation may be determined.

For example, in a case where only the magnetic field strength for the touch operation is determined, a possible implementation of the first preset correspondence may be as follows. If the magnetic field strength for the touch operation is less than the preset magnetic field strength, then the contact end corresponding to the touch operation may be determined to be an end of the finger of the user, and thus the operation instruction corresponding to the contact end may be determined. If the magnetic field strength for the touch operation is not less than the preset magnetic field strength, then the contact end corresponding to the touch operation may be determined to be one end of the capacitive stylus pen, and thus the operation instruction corresponding to this end of the capacitive stylus pen may be determined.

The above implementation based on only the magnetic field strength for the touch operation is suitable to determine whether the manipulation tool is the capacitive stylus pen or the finger of the user, and especially suitable to determine whether the manipulation tool is the capacitive stylus pen or the finger of the user in a case where only one end of the capacitive stylus pen can operate on the touch unit.

Generally, the magnetic field strength for the touch operation at the touch operation point in a case where the capacitive stylus pen touches the touch unit is different from that in a case where the finger touches the touch unit. For example, the magnetic field strength for the touch operation at the touch operation point in the case where the capacitive stylus pen touches the touch unit may be greater than that in the case where the finger touches the touch unit.

Alternatively, the implementation based on only the magnetic field strength for the touch operation is also applicable to a case where the manipulation tool comprises the capacitive stylus pen, both ends of which can each serve as the contact end but correspond to different magnetic field strengths.

For example, in a case where only the magnetic field strength for the touch operation is determined, a possible implementation of the first preset correspondence may be as follows. If the magnetic field strength for the touch operation is less than the preset magnetic field strength, then the contact end corresponding to the touch operation may be determined to be a first end of the capacitive stylus pen, and thus the operation instruction corresponding to the first end may be determined. If the magnetic field strength for the touch operation is not less than the preset magnetic field strength, then the contact end corresponding to the touch operation may be determined to be a second end of the capacitive stylus pen, and thus the operation instruction corresponding to the second end may be determined.

Generally, if the two ends of the capacitive stylus pen correspond to different magnetic field strengths, then the magnetic field strength for the touch operation at the touch operation point in a case where the first end of the capacitive stylus pen touches the touch unit is different from that in a case where the second end of the capacitive stylus pen touches the touch unit. For example, the magnetic field strength for the touch operation at the touch operation point in the case where the first end of the capacitive stylus pen touches the touch unit may be less than that in the case where the second end of the capacitive stylus pen touches the touch unit.

Therefore, the preset magnetic field strength may be established in the first electronic device in advance. The magnetic field strength for the touch operation may be compared with the preset magnetic field strength, to determine the manipulation tool and to determine the contact end. In such an implementation, the determination is relatively simple. After the contact end is determined, the operation instruction corresponding to the contact end may be determined based on the second preset correspondence. As a result, different operation instructions may be determined based on different contact ends, to control the first electronic device to perform different tasks.

Alternatively, in a case where only the magnetic field direction for the touch operation is determined, a possible implementation of the first preset correspondence may be as follows. If the magnetic field direction for the touch operation is a first direction, then the contact end corresponding to the touch operation may be determined to be a first end of the capacitive stylus pen, and thus the operation instruction corresponding to the first end may be determined. If the magnetic field direction for the touch operation is a second direction different from the first direction, then the contact end corresponding to the touch operation may be determined to be a second end of the capacitive stylus pen, and thus the operation instruction corresponding to the second end may be determined.

The first electronic device may comprise at least one detection unit. The detection unit may comprise a magnetic induction unit, such as, a magnetic sensor. The second electronic device may comprise a magnetic component. Thus, if the second electronic device touches the touch unit, the magnetic field direction for the touch operation may be determined through the magnetic induction unit and the magnetic component. The two contact ends of the second electronic device can cause different magnetic field directions when touching the touch unit, due to polarities of the magnetic component. Therefore, the first electronic device may determine which contact end of the second electronic device touches the touch unit based on the magnetic field direction.

Alternatively, the first electronic device can determine both the magnetic field strength and the magnetic field direction for the touch operation, and thus determine which contact end of the second electronic device touches the touch unit based on both the magnetic field strength and the magnetic field direction for the touch operation. As a result, the determination can be more accurate.

Conventionally, the first electronic device may open an application program interface, for example, in response to a double tap on an area of the touch screen by the user with his finger. Likewise, the first electronic device may also open the application program interface, for example, in response to a double tap on the area of the touch screen by the user with the capacitive stylus pen. That is, different contact ends are not distinguished and thus may cause the same response of the first electronic device. In this case, it is impossible to achieve advantages of having different contact ends, so that responses of the electronic device are reduced.

In contrast, according to the technology disclosed herein, the first electronic device may open an application program interface, for example, in response to a double tap on an area of the touch screen by the user with his finger, while may enlarge an object in the area or perform other operations, for example, in response to a double tap on the area of the touch screen by the user with the capacitive stylus pen. That is, the first electronic device may determine which contact end causes the touch operation based on the first preset correspondence, and then determine the operation instruction corresponding to the contact end based on the second preset correspondence. Therefore, different responses can be made based on different contact ends.

The first electronic device may comprise at least one detection unit. The detection unit may comprise a sensor, such as, a magnetic sensor. Then, determining the contact end corresponding to the touch operation information based on the first preset correspondence may comprise: determining a touch operation point on the touch unit corresponding to the touch operation information; determining a distance between the touch operation point and a first detection unit of the at least one detection unit in the electronic device, and determining a field strength increasing rate corresponding to the touch operation point; and determining the contact end corresponding to the touch operation information based on the distance and the field strength increasing rate.

The first detection unit is one selected from the at least one detect unit. According to an embodiment, the first electronic device may determine a distance between the touch operation point and each of the at least one detection unit, for example, in a relatively precise manner or in a relatively coarse manner. To save time, the first electronic device may determine the distance between the touch operation point and each of the at least one detection unit in a coarse manner.

After the electronic device has determined the distance between the touch operation point and each of the at least one detection unit, it may select one from the at least one detection unit, which is closest to the touch operation point, as the first detection unit. Then, the first electronic device may determine the distance between the touch operation point and the first detection unit.

According to an embodiment, the field strength increasing rate corresponding to the touch operation point may be also determined.

Determining the field strength increasing rate corresponding to the touch operation point may comprise: determining a current field strength at the touch operation point; and determining the field strength increasing rate based on the current field strength and an original field strength at the touch operation point.

Determining the original field strength at the touch operation point may comprise determining at least one of a z-axis component of the original field strength at the touch point in a z-axis, an x-axis component of the original field strength at the touch point in an x-axis, a y-axis component of the original field strength at the touch point in a y-axis, and a sum R of the components of the original field strength.

Likewise, determining the current field strength at the touch operation point may comprise determining at least one of a z-axis component of the current field strength at the touch point in the z-axis, an x-axis component of the current field strength at the touch point in the x-axis, a y-axis component of the current field strength at the touch point in the y-axis, and a sum R of the components of the current field strength.

For example, if the z-axis component of the original field strength at the touch point in the z-axis is determined as the original field strength, then the z-axis component of the current field strength at the touch point in the z-axis can be determined as the current field strength. Alternatively, if the x-axis component of the original field strength at the touch point in the x-axis is determined as the original field strength, then the x-axis component of the current field strength at the touch point in the x-axis can be determined as the current field strength. Alternatively, if the y-axis component of the original field strength at the touch point in the y-axis is determined as the original field strength, then the y-axis component of the current field strength at the touch point in the y-axis can be determined as the current field strength. Alternatively, if the sum R of the components of the original field strength at the touch point is determined as the original field strength, then the sum R of the components of the current field strength at the touch point can be determined as the current field strength.

The original field strength, after being determined, may be transformed into a transformed original field strength. Generally, the original field strength is measured in a state where the touch unit has no neighboring objects and is placed completely horizontally, and thus is known in the first electronic device. When the user touches the touch unit, the first electronic device may be moved so that it is no longer placed horizontally, but forms an angle with respect to a horizontal surface. To determine the field strength increasing rate more accurately, the original field strength may be transformed into the transformed original field strength, which in turn can be used to calculate the field strength increasing rate.

According to embodiments of the present disclosure, the z-axis component of the original field strength may be transformed into a transformed z-axis component of the original field strength, the y-axis component of the original field strength may be transformed into a transformed y-axis component of the original field strength, the x-axis component of the original field strength may be transformed into a transformed x-axis component of the original field strength, or the sum R of the components of the original field strength may be transformed into a transformed sum R of the components of the original field strength.

For example, the field strength increasing rate may be calculated according to Equation (1):

L=(T−T1)/T0 (1)

where, L indicates the field strength increasing rate, T indicates the current field strength, T1 indicates the transformed original field strength, and T0 indicates the original field strength.

In a case where T indicates the x-axis component of the current field strength, T1 may indicate the transformed x-axis component of the original field strength, and T0 may indicate the x-axis component of the original field strength. Alternatively, in a case where T indicates the y-axis component of the current field strength, T1 may indicate the transformed y-axis component of the original field strength, and T0 may indicate the y-axis component of the original field strength. Alternatively, in a case where T indicates the z-axis component of the current field strength, T1 may indicate the transformed z-axis component of the original field strength, and T0 may indicate the z-axis component of the original field strength. Alternatively, in a case where T indicates the sum R of the components of the current field strength, T1 may indicate the transformed sum R of the components of the original field strength, and T0 may indicate the sum R of the components of the original field strength.

The first preset correspondence between the contact end and both the distance and the field strength increasing rate may be established in the first electronic device in advance. Then, after determining the distance and the field strength increasing rate, the first electronic device may determine the contact end corresponding to the touch operation point based on the first preset correspondence.

In this case, it suffices to determine only one component of the current field strength and only one component of the original field strength, to determine the contact end. Therefore, it is possible to reduce amounts of data to be processed, and thus reduce loads on the first electronic device.

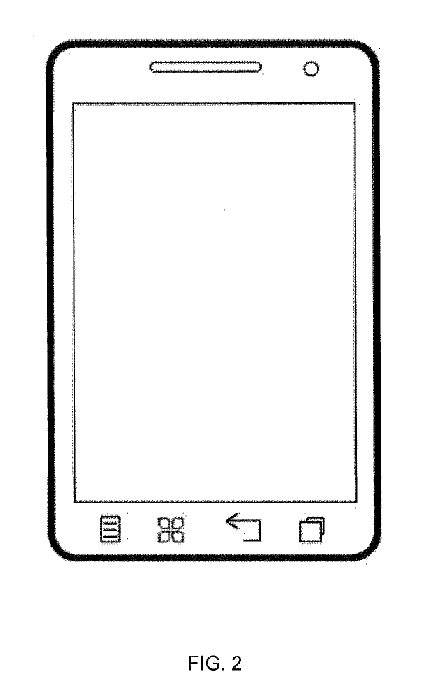

Further, in this case, different components of the field strengths may be used for different areas of the touch unit. For example, reference may be made to FIG. 2, which is a schematic view showing the touch unit of the first electronic device. In the example shown in FIG. 2, the first electronic device comprises a mobile phone. In FIG. 2, “A” indicates a touch operation area of the touch unit, and “B” indicates a detection unit included in the first electronic device, such as a magnetic sensor. In the example of FIG. 2, it is preferred to use the y-axis components of the field strengths for areas of the touch unit above the dashed line, while use the z-axis components of the field strengths for areas of the touch unit below the dashed line. More specifically, it is possible to determine which component can be used for a specific area based on the direction and amount of magnetic lines of force in this area.

According to embodiments of the present disclosure, the first electronic device may establish the first preset correspondence by calibration. The calibration may be implemented in various manners, some of which are exemplified in the following.

### Calibration 1

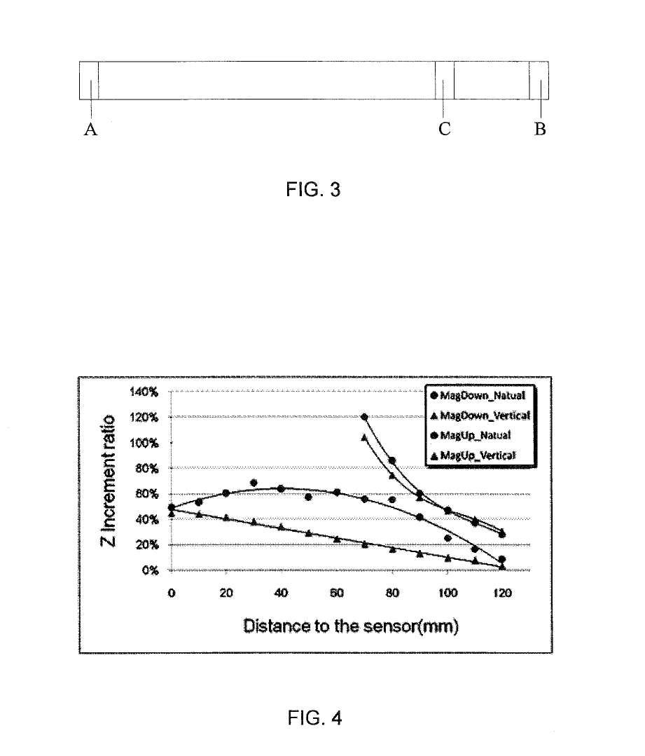

In this example, the second electronic device may comprise a capacitive stylus pen, such as one shown in FIG. 3. As shown in FIG. 3, the capacitive stylus pen may comprise two ends A and B, by which the capacitive stylus pen can operate on the touch unit. The capacitive stylus pen may further comprise a magnetic component C, such as a magnet. In the example shown in FIG. 3, the magnetic component is offset from a center of the capacitive stylus pen. For example, the magnetic component may be distant from the end A by 107 mm, while from the end B by 13 mm.

Various data may be obtained when the capacitive stylus pen is hold in different postures to touch the touch unit with either of its ends. Reference may be made to FIG. 4. In FIG. 4, the horizontal axis represents a distance between the touch operation point of the capacitive stylus pen and a magnetic sensor included in the first electronic device, in a unit of, for example, mm, and the vertical axis represents the field strength increasing rate.

In FIG. 4, four graphs are illustrated. Specifically, graphs 1 and 2 represent data obtained when the end A (FIG. 3) touches the touch unit, that is, the end A is the contact end, while graphs 3 and 4 represent data obtained when the end B (FIG. 3) touches the touch unit, that is, the end B is the contact end. Though FIG. 4 shows only the four graphs, there may be more graphs as desired.

When there are enough such graphs, the first preset correspondence can be established with respect to almost every possible field strength increasing rate and every possible distance. Therefore, it is possible to determine the contact end based on the first preset correspondence.

### Calibration 2

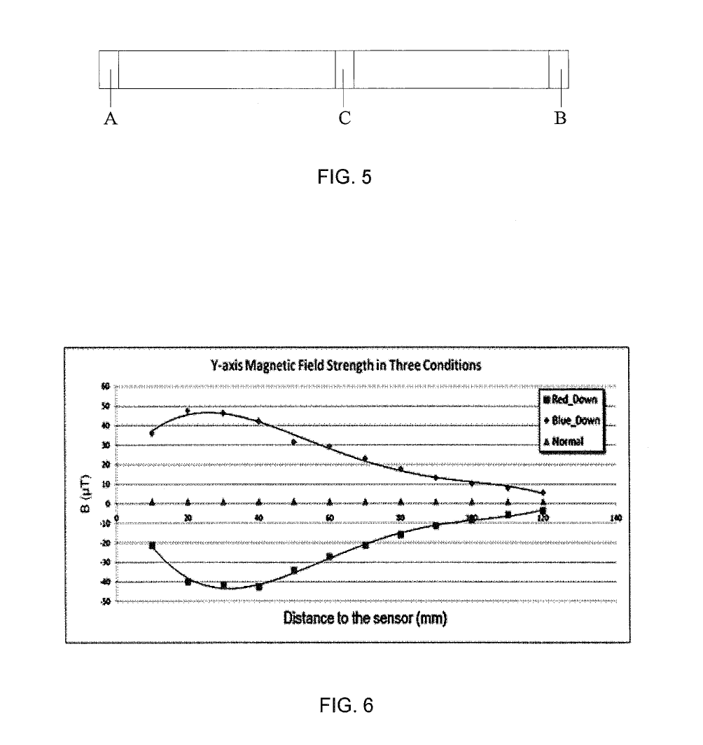

In this example, the second electronic device may comprise a capacitive stylus pen, such as one shown in FIG. 5. As shown in FIG. 5, the capacitive stylus pen may comprise two ends A and B, by which the capacitive stylus pen can operate on the touch unit. The capacitive stylus pen may further comprise a magnetic component C, such as a magnet. In the example shown in FIG. 5, the magnetic component is disposed substantially at a center of the capacitive stylus pen. For example, the magnetic component may be distant from each of the ends A and B by 50 mm.

Various data may be obtained when the capacitive stylus pen is hold in different postures to touch the touch unit with either of its ends. Reference may be made to FIG. 6. In FIG. 6, the horizontal axis represents a distance between the touch operation point of the capacitive stylus pen and a magnetic sensor included in the first electronic device, and the vertical axis represents the field strength increasing rate.

In FIG. 6, two graphs are illustrated. Specifically, graph 1 represents data obtained when the end B (FIG. 5) touches the touch unit, that is, the end B is the contact end, while graph 2 represents data obtained when the end A (FIG. 5) touches the touch unit, that is, the end A is the contact end. Though FIG. 6 shows only the two graphs, there may be more graphs as desired.

In this case, the end B corresponds to an N pole of the magnet included in the capacitive stylus pen, while the end A corresponds to an S pole of the magnet.

When there are enough such graphs, the first preset correspondence can be established with respect to almost every possible field strength increasing rate and every possible distance. Therefore, it is possible to determine the contact end based on the first preset correspondence.

In the above two examples of calibration, they differ only in that the magnet is disposed at different positions in the capacitive stylus pen. Different preset correspondences may be established with respect to different positions of the magnet in the capacitive stylus pen.

According to an embodiment, determining the contact end corresponding to the touch operation information based on the first preset correspondence may comprise: determining a touch operation point on the touch unit corresponding to the touch operation information; determining a coordinate value of the touch operation point, and determining a field strength increasing rate corresponding to the touch operation point; and determining the contact end corresponding to the touch operation information based on the coordinate value and the field strength increasing rate.

For example, an x-axis coordinate value and a y-axis coordinate value of the touch operation point may be determined, and the field strength increasing rate at the touch operation point may be determined. The field strength increasing rate may comprise a z-axis field strength increasing rate at the touch operation point in the z-axis, a y-axis field strength increasing rate at the touch operation point in the y-axis, and an x-axis field strength increasing rate at the touch operation point in the x-axis.

Thus, a piece of 5-dimensional information may be determined. The 5-dimensional information may be represented as (a, b, x, y, z). Here, “a” indicates the x-axis coordinate value of the touch operation point, “b” indicates the y-axis coordinate value of the touch operation point, “x” indicates the x-axis field strength increasing rate at the touch operation point, “y” indicates the y-axis field strength increasing rate at the touch operation point, and “z” indicates the z-axis field strength increasing rate at the touch operation point.

The contact end which is used for the touch operation may be determined based on the coordinate value of the touch operation point and the field strength increasing rate.

This method may be referred to as SVM (Support Vector Machines) classifier algorithm.

According to a further embodiment, the second preset correspondence may be established in the first electronic device in advance. The second preset correspondence may represent associations between different contact ends and different operation instructions. For example, in a case where the manipulation tool is the capacitive stylus pen with two contact ends, the two contact ends may correspond to different operation instructions. As a result, the user may operate with different contact ends to input different operation instructions, which in turn cause the first electronic device to respond differently.

### Embodiment 2

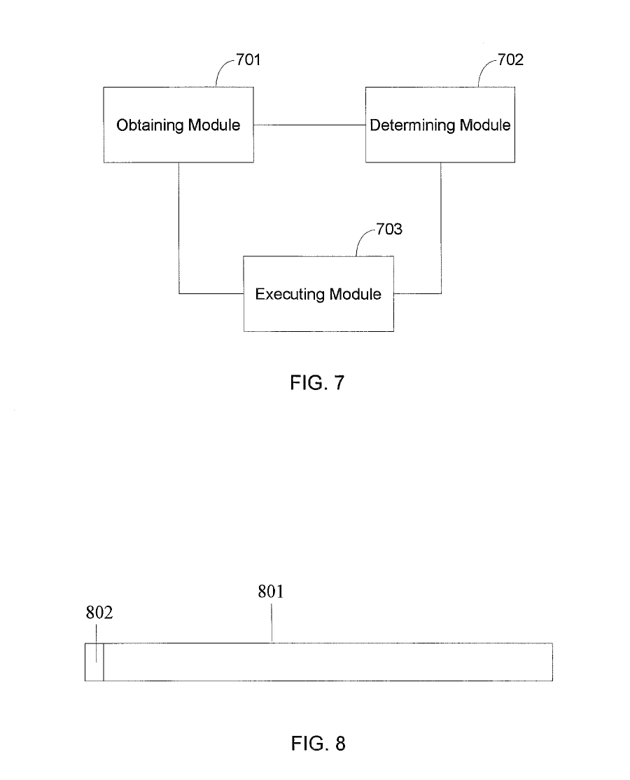

According to a further aspect of the present disclosure, there is provided an electronic device. Referring to FIG. 7, the electronic device may comprise a touch unit, such as a capacitive touch unit or an electromagnetic touch unit. The electronic device may further comprise an obtaining module 701, a determining module 702, and an executing module 703.

The obtaining module 701 may be configured to obtain touch operation information through the touch unit.

The determining module 702 may be configured to determine a contact end corresponding to the touch operation information based on a first preset correspondence, and to determine an operation instruction corresponding to the contact end based on a second preset correspondence.

The executing module 703 may be configured to execute the operation instruction to control the electronic device.

The determining module 702 may be further configured to determine the contact end corresponding to the touch operation information based on a magnetic field strength for a touch operation corresponding to the touch operation information and a preset magnetic field strength, and/or based on a magnetic field direction for a touch operation corresponding to the touch operation information.

The electronic device may further comprise at least one detection unit. The determining module 702 may be further configured to determine a touch operation point on the touch unit corresponding to the touch operation information, determine a distance between the touch operation point and a first detection unit of the at least one detection unit in the electronic device, and determine a field strength increasing rate corresponding to the touch operation point, and determine the contact end corresponding to the touch operation information based on the distance and the field strength increasing rate.

The determining module 702 may be further configured to select one from the at least one detection unit, which is closest to touch operation point, as the first detection unit, and determine the distance between the touch operation point and the first detection unit.

The determining module 702 may be further configured to determine a touch operation point on the touch unit corresponding to the touch operation information, determine a coordinate value of the touch operation point, and determine a field strength increasing rate corresponding to the touch operation point, and determine the contact end corresponding to the touch operation information based on the coordinate value and the field strength increasing rate.

The determining module 702 may be further configured to determine a current field strength at the touch operation point, and determine the field strength increasing rate based on the current field strength and an original field strength at the touch operation point.

The electronic device as described in this embodiment may function similarly to the first electronic device as described in the above embodiments.

### Embodiment 3

According to a still further aspect of the present disclosure, there is provided an electronic device. Referring to FIG. 8, the electronic device may comprise a housing 801 and at least one contact end 802. In the example of FIG. 8, only one end 802 is shown. However, the present disclosure is not limited thereto.

The contact end 802 may be disposed at an end of the housing 801, and may be configured to operate on a touch unit of a further electronic device, such as the first electronic device as described above.

Alternatively, the electronic device may comprise two contact ends, a first one and a second one. The first contact end may correspond to a first magnetic field strength and a first magnetic field direction, while the second contact end may correspond to a second magnetic field strength and a second magnetic field direction. The first magnetic field strength may be equal to or different from the second magnetic field strength, and the first magnetic field direction may be different from the second magnetic field direction.

The electronic device may further comprise a magnetic component provided in the housing 801. The magnetic component may comprise a magnet, for example.

The electronic device may comprise a capacitive stylus pen.

The electronic device as described in this embodiment may function similarly to the second electronic device as described in the above embodiments.

According to a still further aspect of the present disclosure, there is provided a control method for an electronic device with a touch unit, such as a capacitive touch unit or an electromagnetic touch unit. The method may comprise: obtaining touch operation information through the touch unit; determining a contact end corresponding to the touch operation information based on a preset correspondence, and determining an operation instruction corresponding to the contact end; and executing the operation instruction to control the electronic device.

According to embodiments of the present disclosure, the electronic device, after obtaining the touch operation information, may determine the contact end corresponding to the touch operation information based on the preset correspondence and thus determine the operation instruction corresponding to the contact end. As a result, the operation instruction may be executed to control the electronic device. For example, the contact end may comprise any of different ends of a capacitive stylus pen, any of different ends of an electromagnetic stylus pen, a finger of a user, or the like. Based on the preset correspondence, the electronic device can distinguish different contact ends and determine different operation instructions corresponding to the different contact ends, and thus make different responses. Therefore, it is possible to enrich manners in which the electronic device responds to touch operations, and thus to improve user experiences.

In the above descriptions, various functional modules are described only for illustration. However, it is to be understood that each of those functional modules may be embodied in various manners. For example, some or all of the functional modules may be combined with each other or further divided. That is, the device may have different configurations of functional modules, which can perform some or all of functions as described above. The above systems, devices and units may operate similarly to the above method embodiments, and thus detailed descriptions on operations thereof are omitted here.

The systems, devices and units described in the embodiment may be implemented in various manners. The device embodiments are just illustrative, and the modules or units are divided only logically. There may be different divisions of modules or units. For example, some of the units or components may be combined or integrated into a further system, or some of them may be omitted. Further, coupling, direct coupling, or communicative connection may be achieved by some interface, or indirect coupling or communicative connection may be electrical, mechanical, or the like.

Units which are described as separate parts may be or not be physically separated from each other. A component which is shown as a unit may be or not be a physical unit. That is, it may be disposed at one same place, or may be distributed over several network units. It is also feasible to select only some or all of the units to practice the technology disclosed herein.

The various functional units described in the above embodiments may be integrated into a processor, or each of them may exist as an individual entity, or two or more of them may be integrated together. The integrated units may be implemented in either hardware or software.

The integrated units, if implemented in software and thus sold or used as a separate product, may be stored in a computer readable storage medium. Thus, part or all of the technology disclosed herein may be embodied by a software product, which is stored in a storage medium and includes some instructions to cause a computer device (e.g., a personal computer, a server, or a networked device) or a processor to execute some or all of the operations as describe above. The storage medium may comprise a USB disk, a removable hard disk, a Read Only Memory (ROM), a Random Access Memory (RAM), a magnetic disk, or an optical disk.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A control method for an electronic device with a touch unit, the method comprising:
obtaining touch operation information through the touch unit;
determining a contact end corresponding to the touch operation information based on a first preset correspondence, and determining an operation instruction corresponding to the contact end based on a second preset correspondence; and
executing the operation instruction to control the electronic device.

2. The method according to claim 1, wherein determining the contact end corresponding to the touch operation information based on the first preset correspondence comprises determining the contact end corresponding to the touch operation information based on a magnetic field strength for a touch operation corresponding to the touch operation information and a preset magnetic field strength, and/or based on a magnetic field direction for a touch operation corresponding to the touch operation information.

3. The method according to claim 1, wherein the electronic device comprises at least one detection unit, and determining the contact end corresponding to the touch operation information based on the first preset correspondence comprises:
determining a touch operation point on the touch unit corresponding to the touch operation information;
determining a distance between the touch operation point and a first detection unit of the at least one detection unit in the electronic device, and determining a field strength increasing rate corresponding to the touch operation point; and
determining the contact end corresponding to the touch operation information based on the distance and the field strength increasing rate.

4. The method according to claim 3, wherein determining the distance between the touch operation point and the first detection unit comprises:
selecting one from the at least one detection unit, which is closest to the touch operation point, as the first detection unit; and
determining the distance between the touch operation point and the first detection unit.

5. The method according to claim 1, wherein determining the contact end corresponding to the touch operation information based on the first preset correspondence comprises:
determining a touch operation point on the touch unit corresponding to the touch operation information;
determining a coordinate value of the touch operation point, and determining a field strength increasing rate corresponding to the touch operation point; and
determining the contact end corresponding to the touch operation information based on the coordinate value and the field strength increasing rate.

6. The method according to claim 3, wherein determining the field strength increasing rate corresponding to the touch operation point comprises:
determining a current field strength at the touch operation point; and
determining the field strength increasing rate based on the current field strength and an original field strength at the touch operation point.

7. An electronic device, comprising:
a touch unit;
an obtaining module configured to obtain touch operation information through the touch unit;
a determining module configured to determine a contact end corresponding to the touch operation information based on a first preset correspondence, and to determine an operation instruction corresponding to the contact end based on a second preset correspondence; and
an executing module configured to execute the operation instruction to control the electronic device.

8. The electronic device according to claim 7, wherein the determining module is further configured to determine the contact end corresponding to the touch operation information based on a magnetic field strength for a touch operation corresponding to the touch operation information and a preset magnetic field strength, and/or based on a magnetic field direction for a touch operation corresponding to the touch operation information.

9. The electronic device according to claim 7, further comprising at least one detection unit, wherein the determining module is further configured to:
determine a touch operation point on the touch unit corresponding to the touch operation information;
determine a distance between the touch operation point and a first detection unit of the at least one detection unit in the electronic device, and determine a field strength increasing rate corresponding to the touch operation point; and
determine the contact end corresponding to the touch operation information based on the distance and the field strength increasing rate.

10. The electronic device according to claim 9, wherein the determining module is further configured to:
select one from the at least one detection unit, which is closest to touch operation point, as the first detection unit; and
determine the distance between the touch operation point and the first detection unit.

11. The electronic device according to claim 7, wherein the determining module is further configured to:
determine a touch operation point on the touch unit corresponding to the touch operation information;
determine a coordinate value of the touch operation point, and determine a field strength increasing rate corresponding to the touch operation point; and
determine the contact end corresponding to the touch operation information based on the coordinate value and the field strength increasing rate.

12. The electronic device according to claim 9, wherein the determining module is further configured to:
determine a current field strength at the touch operation point; and
determine the field strength increasing rate based on the current field strength and an original field strength at the touch operation point.

13. An electronic device, comprising:
a housing; and
at least one contact end, one of which is disposed at an end of the housing and configured to operate on a touch unit of a further electronic device.

14. The electronic device according to claim 13, wherein the electronic device comprises two contact ends, a first one of which corresponds to a first magnetic field strength and a first magnetic field direction, and a second one of which corresponds to a second magnetic field strength and a second magnetic field direction, wherein the first magnetic field strength is equal to or different from the second magnetic field strength, and the first magnetic field direction is different from the second magnetic field direction.

15. The electronic device according to claim 13, further comprising a magnetic component provided in the housing.
